(19) United States
(12) Patent Application Publication
(10) Pub. No.: US 2025/0366581 A1
(43) Pub. Date: Dec. 4, 2025

(54) HEATED LUNCH BOX

(71) Applicant: Weilin HUANG, Guigang (CN)

(72) Inventor: Weilin HUANG, Guigang (CN)

(21) Appl. No.: 18/680,417

(22) Filed: May 31, 2024

(51) Int. Cl. A45C 11/20; A47J 36/24

(52) U.S. Cl. CPC A45C 11/20; A47J 36/2483

(57) ABSTRACT

Provided is a heated lunch box, including an outer shell, an electric heating device, and an inner container, where the electric heating device is fixedly installed at the bottom of the outer shell, and the inner container is disposed on the electric heating device; the electric heating device and a power supply circuit are connected through a bimetallic thermostat; and the bimetallic thermostat includes a mounting support, a temperature control shaft, an insulation assembly, a bimetallic plate, a spring plate mechanism, and a porcelain post insulator, where the insulation assembly and the temperature control shaft are installed on the mounting support, the spring plate mechanism is installed on the insulation assembly, and two ends of the porcelain post insulator are respectively connected to the spring plate mechanism and the bimetallic plate.

### TECHNICAL FIELD

The present invention relates to the field of portable tableware, and in particular, to a heated lunch box.

### BACKGROUND

A heated lunch box is a lunch box with a heating function. In addition to the functions of an insulated lunch box and an ordinary lunch box, it can be heated again. Existing heated lunch boxes in the prior art are switched off after reaching a preset temperature and have a good heating effect. However, the heating temperature of these lunch boxes cannot be adjusted, and a user needs to observe the temperature during the heating process.

### SUMMARY

In view of the above defect, the present invention is intended to provide a heated lunch box that is capable of presetting the heating temperature and easy to operate, and has a reliable structure.

To achieve the objective, technical solutions adopted by the present invention are as follows:

A heated lunch box, including an outer shell, an electric heating device, and an inner container, where the electric heating device is fixedly installed at the bottom of the outer shell, and the inner container is disposed on the electric heating device;

the electric heating device and a power supply circuit are connected through a bimetallic thermostat;

the bimetallic thermostat includes a mounting support, a temperature control shaft, an insulation assembly, a bimetallic plate, a spring plate mechanism, and a porcelain post insulator, where the insulation assembly and the temperature control shaft are installed on the mounting support, the spring plate mechanism is installed on the insulation assembly, and two ends of the porcelain post insulator are respectively connected to the spring plate mechanism and the bimetallic plate; and

the spring plate mechanism includes a spring plate and a fixed contact plate spaced apart on the insulation assembly, where the spring plate is fixedly connected to a movable contact plate, the movable contact plate is provided with a movable contact, the fixed contact plate is provided with a fixed contact matching the movable contact, and the two ends of the porcelain post insulator are respectively connected to the bimetallic plate and the spring plate.

Preferably, the electric heating device includes a tray, a heating element, and a mounting bracket; and

the mounting bracket is fixed to the tray through screws, and the heating element is press-fitted between the tray and the mounting bracket by the mounting bracket.

Further, the temperature control shaft of the bimetallic thermostat protrudes from the outer shell.

One of the above technical solutions has the following beneficial effects: for the heated lunch box proposed in the technical solution, first the temperature control shaft is rotated after start-up so that the temperature control shaft presses down the spring plate to drive the movable contact plate to press down and approach the fixed contact plate, thereby causing the movable contact to be in contact with the fixed contact, and by providing the bimetallic thermostat to control heating and heat preservation, when the temperature sensed by the thermostat reaches a preset temperature, the bimetallic plate is heated and bends towards the porcelain post insulator, and the porcelain post insulator pushes up the movable contact plate of the spring plate mechanism so that the movable contact and the fixed contact are separated to switch off the heating power supply; and after the temperature drops, the bimetallic plate is reset so that the movable contact and the fixed contact are in contact with each other, and power is supplied to the electric heating device for heating.

### BRIEF DESCRIPTION OF DRAWINGS

FIG. 1 is a schematic structural diagram of an electric heating device in accordance with one embodiment of the present invention; and

FIG. 2 is a schematic structural diagram of a bimetallic thermostat in accordance with one embodiment of the present invention.

Reference signs: 1: electric heating device; 11: tray; 12: heating element; 13: mounting bracket; 2: bimetallic thermostat; 21: mounting support; 22: temperature control shaft; 23: insulation assembly; 24: bimetallic plate; 25: spring plate mechanism; 251: spring plate; 252: fixed contact plate; 253: movable contact plate; 254: movable contact; 255: fixed contact; and 26: porcelain post insulator.

### DETAILED DESCRIPTION OF THE EMBODIMENTS

Embodiments of the present invention are described in detail below and examples of the embodiments are shown in the accompanying drawings, where the same or similar reference signs always represent the same or similar elements or elements with the same or similar functions. The embodiments described below with reference to the accompanying drawings are exemplary only for explaining the present invention and should not be construed as limiting the present invention.

In the description of the present invention, it should be understood that the orientations or positional relationships indicated by the terms “longitudinal”, “transverse”, “upper”, “lower”, “front”, “rear”, “left”, “right”, “vertical”, “horizontal”, “top”, “bottom”, “inside”, “outside”, and the like are in accordance with those shown in the accompanying drawings, intended only for the convenience of describing the present invention and simplifying the description rather than for indicating or implying that the referred devices or elements must be provided with a particular orientation or constructed or operated in a particular orientation; therefore, these terms should not be construed as limiting the present invention. Moreover, features defined by the terms “first” and “second” may explicitly or implicitly include one or more of these features, and these terms are used to distinguish and describe the features without distinction of order or importance.

In the description of the present invention, it should be noted that, unless otherwise explicitly provided and limited, the terms “mounted”, “attached”, and “connected” should be understood in a broad sense, e.g., it may be a fixed connection, a detachable connection, or an integral connection; it may be a mechanical connection or an electrical connection; it may be a direct connection or an indirect connection through an intermediate medium; and it may be a connection between two elements. For those of ordinary skill in the art, the specific meanings of the above terms herein can be understood on a case-by-case basis.

In the description of the present invention, unless otherwise specified, “a plurality of” refers to two or more.

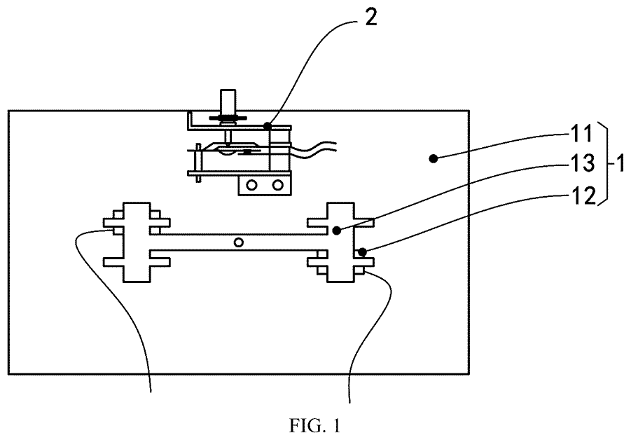

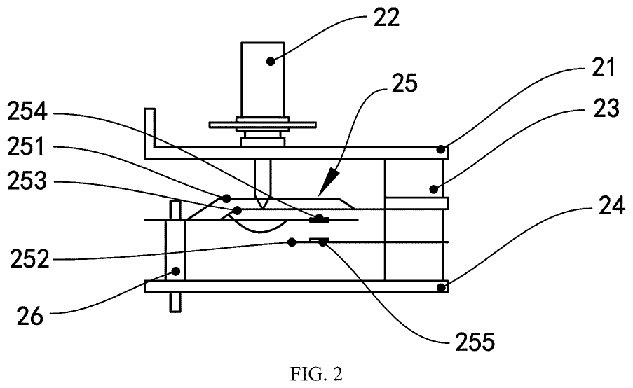

As shown in FIGS. 1-2, a heated lunch box is provided, including an outer shell, an electric heating device 1, and an inner container, where the electric heating device 1 is fixedly installed at the bottom of the outer shell, and the inner container is disposed on the electric heating device 1; the electric heating device 1 and a power supply circuit are connected through a bimetallic thermostat 2;

the bimetallic thermostat 2 includes a mounting support 21, a temperature control shaft 22, an insulation assembly 23, a bimetallic plate 24, a spring plate mechanism 25, and a porcelain post insulator 26, where the insulation assembly 23 and the temperature control shaft 22 are installed on the mounting support 21, the spring plate mechanism 25 is installed on the insulation assembly 23, and two ends of the porcelain post insulator 26 are respectively connected to the spring plate mechanism 25 and the bimetallic plate 24; and

the spring plate mechanism 25 includes a spring plate 251 and a fixed contact plate 252 spaced apart on the insulation assembly 23, where the spring plate 251 is fixedly connected to a movable contact plate 253, the movable contact plate 253 is provided with a movable contact 254, the fixed contact plate 252 is provided with a fixed contact 255 matching the movable contact 254, and the two ends of the porcelain post insulator 26 are respectively connected to the bimetallic plate 24 and the spring plate 251.

For the heated lunch box proposed in the technical solution, first the temperature control shaft 22 is rotated after start-up so that the temperature control shaft 22 presses down the spring plate 251 to drive the movable contact plate 253 to press down and approach the fixed contact plate 252, thereby causing the movable contact 254 to be in contact with the fixed contact 255, and by providing the bimetallic thermostat 2 to control heating and heat preservation, when the temperature sensed by the thermostat reaches a preset temperature, the bimetallic plate 24 is heated and bends towards the porcelain post insulator 26, and the porcelain post insulator 26 pushes up the movable contact plate 253 of the spring plate mechanism so that the movable contact and the fixed contact are separated to switch off the heating power supply; and after the temperature drops, the bimetallic plate 24 is reset so that the movable contact and the fixed contact are in contact with each other, and power is supplied to the electric heating device for heating.

The electric heating device 1 includes a tray 11, a heating element 12, and a mounting bracket 13; and

the mounting bracket 13 is fixed to the tray 11 through screws, and the heating element 12 is press-fitted between the tray 11 and the mounting bracket 13 by the mounting bracket 13.

The heating element is fixed to the tray 11 through the mounting bracket so that the tray is directly heated.

The temperature control shaft 22 of the bimetallic thermostat 2 protrudes from the outer shell so that it is convenient for a user to use the shaft 22 for temperature control.

The technical principles of the present invention are described above in conjunction with embodiments. These descriptions are only for explaining the principles of the present invention and should not be construed as limiting the protection scope of the present invention in any way. Therefore, those skilled in the art may derive other implementation manners of the present invention without any creative effort, and these manners should all fall within the protection scope of the present invention.

What is claimed is:

1. A heated lunch box, comprising an outer shell, an electric heating device, and an inner container, wherein the electric heating device is fixedly installed at the bottom of the outer shell, and the inner container is disposed on the electric heating device;
the electric heating device and a power supply circuit are connected through a bimetallic thermostat;
the bimetallic thermostat comprises a mounting support, a temperature control shaft, an insulation assembly, a bimetallic plate, a spring plate mechanism, and a porcelain post insulator, wherein the insulation assembly and the temperature control shaft are installed on the mounting support, the spring plate mechanism is installed on the insulation assembly, and two ends of the porcelain post insulator are respectively connected to the spring plate mechanism and the bimetallic plate; and
the spring plate mechanism comprises a spring plate and a fixed contact plate spaced apart on the insulation assembly, wherein the spring plate is fixedly connected to a movable contact plate, the movable contact plate is provided with a movable contact, the fixed contact plate is provided with a fixed contact matching the movable contact, and the two ends of the porcelain post insulator are respectively connected to the bimetallic plate and the spring plate.

2. The heated lunch box of claim 1, wherein the electric heating device comprises a tray, a heating element, and a mounting bracket; and
the mounting bracket is fixed to the tray through screws, and the heating element is press-fitted between the tray and the mounting bracket by the mounting bracket.

3. The heated lunch box of claim 2, wherein the temperature control shaft of the bimetallic thermostat protrudes from the outer shell.
